(19) United States
(12) Patent Application Publication
(10) Pub. No.: US 2017/0346395 A1
(43) Pub. Date: Nov. 30, 2017

(54) SYSTEM AND METHOD FOR CONTROLLING POWER MODULE

(71) Applicant: Hyundai Motor Company, Seoul (KR)

(72) Inventors: Ki Jong Lee, Osan (KR); Kang Ho Jeong, Changwon (KR); Ji Woong Jang, Hwaseong (KR); Sang Cheol Shin, Suwon (KR)

(21) Appl. No.: 15/272,791

(22) Filed: Sep. 22, 2016

(30) Foreign Application Priority Data
May 24, 2016 (KR) 10-2016-0063231

(51) Int. Cl. H02M 3/156

(52) U.S. Cl. CPC H02M 3/156

(57) ABSTRACT

A system and method for controlling a power module are provided. The system includes a switch element that adjusts output of a power module, a driving signal generation unit that generates a switch ON signal and a switch OFF signal for the switch element, and a latch that is connected between the driving signal generation unit and the switch element and is configured to delay the switch ON signal generated by the driving signal generation unit by a preset delay time and transfer a delayed signal to the switch element. Additionally, a compensation unit is connected between the latch and the power module and is configured to adjust the output of the power module during the delay time by which the latch delays the switch ON signal.

### CROSS REFERENCE TO RELATED APPLICATION

The present application claims priority to Korean Patent Application No. 10-2016-0063231, filed May 24, 2016 the entire contents of which is incorporated herein for all purposes by this reference.

### BACKGROUND

### 1. Field of the Invention

The present invention relates to a system and method for controlling a power module, which improve the electromagnetic performance of a power module used in power devices and also improve the precision of detection of an arm short.

### 2. Description of the Related Art

Generally, components in various types of electronic and electric products are supplied with power for operation. In particular, under the influence of noise (including electromagnetic waves) attributable to various types of causes, such as power instability or circuit instability, unnecessary power consumption occurs, and the lifespan of electronic or electric products is decreased.

The causes of such noise may be classified into three types. First, there is an intrinsic noise source, which includes thermal noise or the like produced due to the intrinsic attributes of a physical system. Second, there is man-made noise, which denotes noise produced by devices, such as motors, switches, digital devices, or antennas. Third, there is natural noise, which includes, for example, noise attributable to lighting or a sunspot. Regardless of the cause of noise production, noise undesirably influences electric and electronic devices, and it may be difficult to completely eliminate such noise. However, a method has been developed to reduce noise to a degree that does not influence the original function of an electric or electronic device.

Meanwhile, when electromagnetic noise occurring in electric and electronic devices is classified based on the shape thereof, the noise may be divided into conducted noise that is externally output via a power line and radiated noise that is radiated to the air in the shape of electromagnetic waves. A conductor itself passing through an environment having noise is influenced by the noise, and also transfers the noise to other portions of a system. Further, in the place where charges are moving, electromagnetic waves are always generated, and such an electromagnetic wave becomes the principal cause of influencing other circuits. A phenomenon in which generated noise negatively influences electric and electronic devices in any form is called electromagnetic interference. Many countries independently establish criteria and provide regulations regarding such electromagnetic interference, and thus it may be difficult to produce and sell products unless the products satisfy the regulations.

The foregoing is intended merely to aid in the better understanding of the background of the present invention, and is not intended to mean that the present invention falls within the purview of the related art that is already known to those skilled in the art.

### SUMMARY

Accordingly, the present invention provides a power module control system and method, in which a turn-on configuration for a power module is implemented in two stages, thus minimizing electromagnetic interference that occurs when the power module is turned on and enabling an arm short in a switch element for operating the power module to be detected.

In order to accomplish the above object, the present invention provides a system for controlling a power module that may include a switch element configured to adjust output of a power module; a driving signal generation unit configured to generate a switch ON signal and a switch OFF signal for the switch element; a latch connected between the driving signal generation unit and the switch element and configured to delay the switch ON signal generated by the driving signal generation unit by a preset delay time and transfer a delayed signal to the switch element; and a compensation unit connected between the latch and the power module and configured to adjust the output of the power module during the delay time by which the latch delays the switch ON signal.

The switch element may be a complementary metal-oxide-semiconductor (CMOS) device, and the switch ON signal and the switch OFF signal generated by the driving signal generation unit may be applied to a gate of the CMOS device. The system may further include an arm short detection unit connected between the latch and the power module and configured to detect whether an arm short has occurred in the power module during the delay time by which the latch delays the switch ON signal. The arm short detection unit may have a first resistor and a second resistor connected in series, and may be configured to detect whether an arm short has occurred in the power module using a voltage value applied to the first resistor during the delay time. The delay time may increase as a value of a time constant of the latch becomes larger.

After the delay time by which the latch delays the switch ON signal has elapsed, the adjustment of the output of the power module using the compensation unit may be terminated, and the switch element for receiving the switch ON signal from the latch may be configured to adjust the output of the power module. The power module may be implemented as a MOSFET, and the adjustment of output of the MOSFET by the compensation unit and the switch element may be performed by adjusting a voltage value applied to a gate of the MOSFET. A voltage value applied to the gate of the MOSFET by the switch element may be greater than a voltage value applied to the gate of the MOSFET by the compensation unit.

Further, the present invention provides a method for controlling a power module that may include when a driving signal generation unit, configured to generate an ON signal and an OFF signal for a switch element for adjusting output of a power module, generates the ON signal for the switch element, allowing a latch configured to receive the ON signal to transfer the OFF signal to the switch element during a preset delay time, and allowing a compensation unit that receives the ON signal to adjust output of the power module during the preset delay time; and when the delay time has elapsed after the latch receives the ON signal, terminating adjustment of the output of the power module using the compensation unit, and adjusting the output of the power module using the switch element.

The adjustment of the output of the power module may be performed by adjusting a voltage value applied to a gate of a MOSFET constituting the power module. A voltage value applied to the gate of the MOSFET by the switch element may be greater than a voltage value applied to the gate of the MOSFET by the compensation unit.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a configuration diagram showing a system for controlling a power module according to an exemplary embodiment of the present invention;

FIG. 2 is a flowchart showing a method for controlling a power module according to an exemplary embodiment of the present invention;

FIG. 3 is a graph showing the output of the power module according to an exemplary embodiment of the present invention; and

FIGS. 4A and 4B are graphs showing the results of Radio Frequency Interference (RFI) Amplitude Modulation (AM) evaluation between the conventional technology and the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Hereinafter, exemplary embodiments of the present invention will be described in detail with reference to the attached drawings.

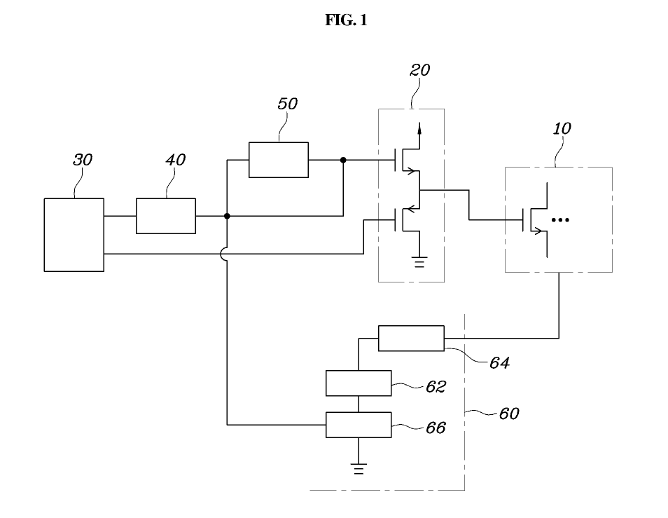

As shown in FIG. 1, a system for controlling a power module 10 according to the present invention may include a switch element 20 configured to adjust the output of the power module 10; a driving signal generation unit 30 configured to generate an ON signal and an OFF signal for the switch element 20; a latch 40 connected between the driving signal generation unit 30 and the switch element 20 and configured to delay the switch ON signal generated by the driving signal generation unit 30 by a preset delay time and to transfer the delayed switch ON signal to the switch element 20; a compensation unit 50 connected between the latch 40 and the power module 10 and configured to adjust the output of the power module 10 during the delay time by which the latch 40 delays the switch ON signal; and an arm short detection unit 60 connected between the latch 40 and the power module 10 and configured to detect whether an arm short occurs in the power module 10 during the delay time by which the latch 40 delays the switch ON signal. The various units may be operated by a controller having a processor and a memory.

In particular, the power module 10 according to the present invention may be implemented in various forms, and in FIG. 1, a metal-oxide-semiconductor field-effect transistor (MOSFET) is shown as a representative shape of the power module 10. However, the power module 10 described in the present invention may be implemented using various semiconductor devices (e.g. Bipolar Junction Transistor: BJT or the like) including a MOSFET. When the power module 10 is implemented as a MOSFET, the output of the power module 10 may be adjusted based on a gate voltage applied to the MOSFET. In particular, such a control method differs according to the type of MOSFET. As shown in FIG. 1, when the power module 10 is an NMOS transistor, the power module 10 may be turned on when the voltage applied to the gate thereof is equal to or greater than a predetermined voltage (e.g. a threshold voltage).

Therefore, to adjust the output of the power module 10, the present invention configures the switch element 20. In FIG. 1, among various shapes of the switch elements 20, a complementary metal-oxide-semiconductor (CMOS)-type switch element 20 is illustrated. Particularly, CMOS devices have many advantages, such as low price, as well as high switching speed and low power consumption, compared to other types of switch elements 20, and thus the present invention presents the system for controlling the power module 10 using a CMOS device.

To determine the switching of the CMOS device constituting the switch element 20, signals applied to the gates of an NMOS transistor and a PMOS transistor constituting the CMOS device may be adjusted. In the present invention, the ON signal and the OFF signal generated by the driving signal generation unit 30 may be applied to the gates of the CMOS device, thus executing the switching of the switch element 20. As described above, the present invention is a system for executing the turn-on operation of the power module 10 in two stages. In particular, when the power module 10 is turned on in two stages, the rate of variation in the output of the power module 10 may be smoother and when the power module 10 is turned on, a peak value that may instantaneously appear may be decreased.

Therefore, the present invention is configured to add the structure of the latch 40 and the compensation unit 50 to implement a two-stage turn-on operation for the power module 10. The latch 40 is a component for secondarily turning on the power module 10 in the present invention, and may be configured to delay the switch ON signal generated by the driving signal generation unit 30 by a preset delay time and transfer the delayed switch ON signal to the switch element 20. The compensation unit 50 is a component for primarily turning on the power module 10, and may be configured to adjust the output of the power module 10 during the delay time.

Furthermore, the graph in FIG. 3 shows that the driving signal generation unit 30 may be configured to generate an ON signal at the moment at which time reaches t₁. Thereafter, when time reaches t₂, the output of the power module 10 may be increased. This point is the time at which the power module 10 may be primarily turned on, and at which the power module 10 may be operated by the compensation unit 50. An increase in the output of the power module 10, after a predetermined period (t₂−t₁) has elapsed from the transmission of the switch ON signal by the driving signal generation unit 30, may be regarded as being due to a response delay, fundamentally present in a circuit.

The period during which the output of the power module 10 is adjusted by the compensation unit 50 is the interval from t₂ to t₃ in the graph of FIG. 3. Therefore, the delay time that is the period during which the compensation unit 50 described in the present invention controls the power module 10 may be regarded as the time obtained by subtracting t₂ from t₃, by referring to the graph of FIG. 3. This delay time may be adjusted based on the magnitude of the time constant of the latch 40, and may increase as the magnitude of the time constant increases. When an RC circuit is configured in the latch 40, the value of the time constant is R*C, and thus the delay time may be adjusted to meet the requirements of a designer by adjusting the resistance of a resistor R and the capacitance of a capacitor C constituting the latch 40.

Additionally, when the delay time has elapsed since the compensation unit 50 started to adjust the output of the power module 10, the adjustment of output of the power module 10 by the compensation unit 50 may be terminated, and the switch element 20 configured to receive a switch ON signal from the latch 40 may be configured to adjust the output of the power module 10. In other words, at this time, the secondary turn-on operation of the power module 10 may be started, and a period after t3 corresponds to this time in FIG. 3.

The point to be noted in the secondary turn-on operation in FIG. 3 is the difference between the output values of the power module 10 during the primary turn-on operation and the secondary turn-on operation. The output value of the power module 10 in the secondary turn-operation may be increased compared to that in the primary turn-on operation. In particular, to improve the electromagnetic performance of the power module 10, the output of the power module 10 in the primary turn-on operation may be set to a value less than that in the secondary turn-on operation. Therefore, in the present invention, to decrease the output of the power module 10 in the secondary turn-on operation compared to the output of the power module 10 in the primary turn-on operation, a turn-on signal for the power module 10 implemented by the compensation unit 50 and a turn-on signal for the power module 10 implemented by the switch element 20 may be set to different signals. This method may be implemented using various methods based on which elements have been used to configure the power module 10.

As an example of the present invention, a method is provided for increasing the voltage value applied to the power module 10 by the switch element 20 to be greater than the voltage value applied to the power module 10 by the compensation unit 50. In addition to this method, various methods, such as a method for increasing a duty ratio obtained by the switch element 20 to be greater than a duty ratio obtained by the compensation unit 50, may be considered.

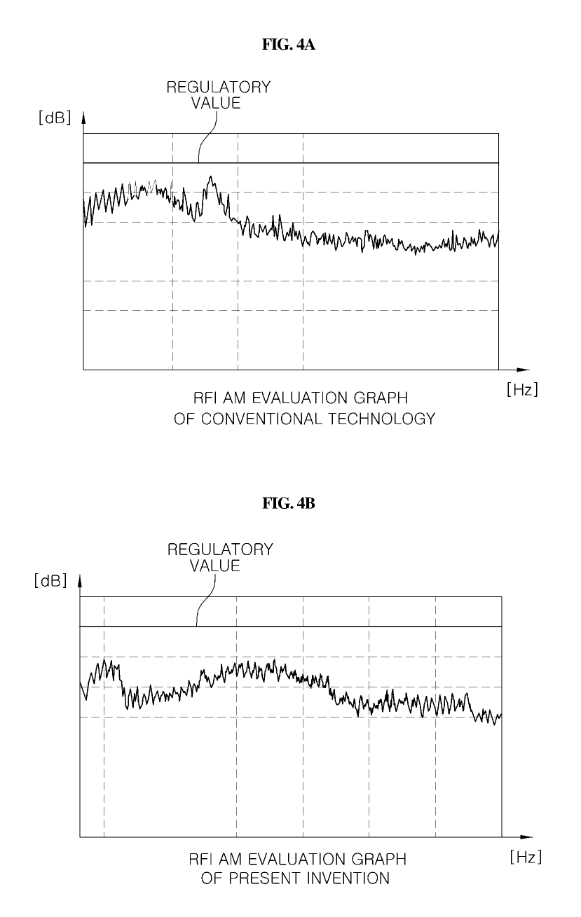

In FIGS. 4A and 4B, to detect the effects of improvement of electromagnetic performance according to the present invention, a graph for RFI AM evaluation according to the conventional technology and a graph for RFI AM evaluation according to the present invention are compared with each other. According to the conventional technology, the magnitudes of RFI values are not substantially different from a regulatory value. However, according to the technology of the present invention, RFI values of AM are less than the RFI values of the conventional technology, and a margin for the regulatory value is increased. Thus, the present invention may further improve electromagnetic performance compared to the conventional technology.

Based on the configuration described herein above, the turn-on configuration of the power module 10 may be implemented in two stages. In particular, an arm short may occur in the power module 10 during a delay time during which the power module 10 is operated by the compensation unit 50. Therefore, in the present invention, the arm short detection unit 60 may be provided separately to detect an arm short occurring in the power module 10 during the delay time.

The arm short detection unit 60 may be implemented in various shapes, and may be configured to detect whether an arm short has occurred in the power module 10 during the delay time. Therefore, as shown in FIG. 1, the arm short detection unit 60 may include a first resistor 64 and a second resistor 62 connected in series and connected to the power module 10, and may further include a switch unit 66 connected between the second resistor 62 and a ground and configured to receive a signal from the latch 40. Since a signal, transmitted from the latch 40 during the delay time, may be a switch OFF signal, the switch used for the arm short detection unit 60 for the object may be implemented as a PMOS or a PNP transistor. Therefore, when the value of a voltage, applied to the first resistor 64 constituting the arm short detection unit 60 during the delay time, becomes equal to or greater than a predetermined reference voltage, the arm short detection unit 60 may be configured to detect that an arm short has occurred in the power module 10. Particularly, the predetermined reference voltage may have various values based on the sizes (resistances) of the first resistor 64 and the second resistor 62, the output of the power module 10, and the requirements of a designer.

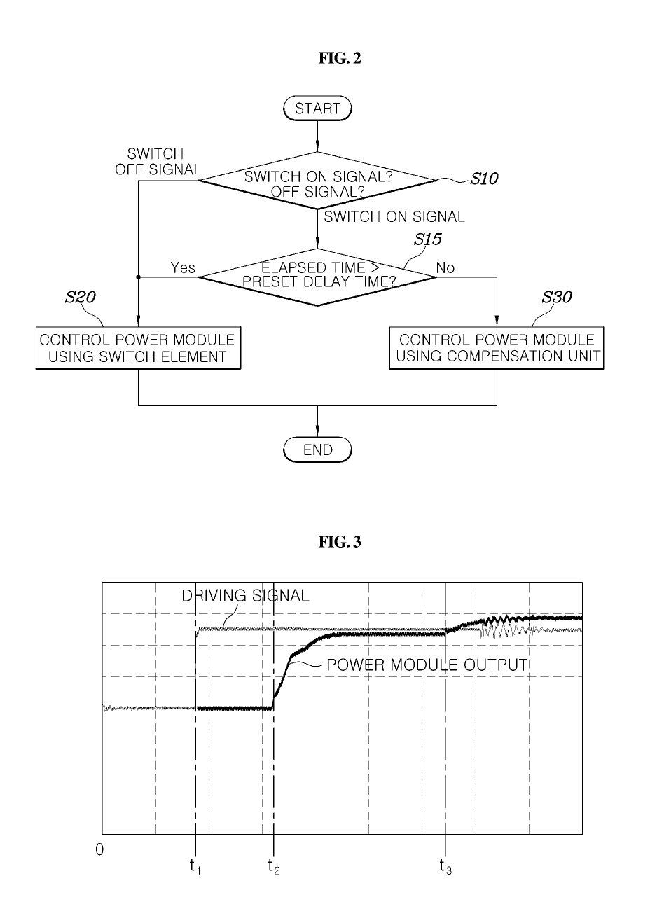

In addition, a method for controlling the power module 10 according to the present invention is configured, as shown in FIG. 2. The method for controlling the power module 10 may vary based on which one of a switch ON signal and a switch OFF signal is to be generated by the driving signal generation unit 30, configured to generate a switch ON signal and a switch OFF signal for the switch element 20 for adjusting the output of the power module 10, at step S10.

When the switch OFF signal is generated, the power module 10 is not required to turn on. In particular, a secondary turn-on operation is not required, as described above, and the step S20 of operating the power module 10 using the switch element 20 may be performed. In contrast, when the switch ON signal for the switch element 20 is generated, different control methods may be used based on whether an elapsed time is greater than a preset delay time at step S15. When the elapsed time is less than or equal to the preset delay time corresponds to a first-stage turn-on configuration in the two-stage turn-on configuration. Thus, as described above, the step S30 of operating the power module 10 using the compensation unit 50 may be performed. When time has elapsed and exceeds the preset delay time, the time to perform a secondary turn-on operation has been reached, and thus step S20 of operating the power module 10 the switch element 20 may be performed.

As described above, the present invention is advantageous in that a turn-on configuration for a power module may be configured in two stages, and thus, noise occurring in a turn-on operation may be reduced, thus minimizing electromagnetic interference, and an arm short in a switch element for operating the power module may be detected, thus minimizing the occurrence of a failure in the power module attributable to the occurrence of the arm short. Therefore, the present invention may improve the durability of the power module, and may enhance the signal reception performance of a radio set when the power module according to the present invention having improved electromagnetic performance is applied to the radio set.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A system for controlling a power module, comprising:
a switch element configured to adjust output of a power module;
a driving signal generation unit configured to generate a switch ON signal and a switch OFF signal for the switch element;
a latch connected between the driving signal generation unit and the switch element and configured to delay the switch ON signal generated by the driving signal generation unit by a preset delay time and transfer a delayed signal to the switch element; and
a compensation unit connected between the latch and the power module and configured to adjust the output of the power module during the delay time by which the latch delays the switch ON signal.

2. The system of claim 1, wherein the switch element is a complementary metal-oxide-semiconductor (CMOS) device, and the switch ON signal and the switch OFF signal generated by the driving signal generation unit are applied to a gate of the CMOS device.

3. The system of claim 1, further comprising:
an arm short detection unit connected between the latch and the power module and configured to detect whether an arm short has occurred in the power module during the delay time by which the latch delays the switch ON signal.

4. The system of claim 3, wherein the arm short detection unit includes a first resistor and a second resistor connected in series, and is configured to detect whether an arm short has occurred in the power module using a voltage value applied to the first resistor during the delay time.

5. The system of claim 1, wherein the delay time increases as a value of a time constant of the latch increases.

6. The system of claim 1, wherein, after the delay time by which the latch delays the switch ON signal has elapsed, adjustment of the output of the power module using the compensation unit is terminated, and the switch element configured to receive the switch ON signal from the latch adjusts the output of the power module.

7. The system of claim 6, wherein the power module is implemented as a MOSFET, and adjustment of output of the MOSFET using the compensation unit and the switch element is performed by adjusting a voltage value applied to a gate of the MOSFET.

8. The system of claim 7, wherein a voltage value applied to the gate of the MOSFET by the switch element is greater than a voltage value applied to the gate of the MOSFET by the compensation unit.

9. A method for controlling a power module, comprising:
when a driving signal generation unit, configured to generate an ON signal and an OFF signal for a switch element for adjusting output of a power module, generates the ON signal for the switch element, allowing a latch configured to receive the ON signal to transfer the OFF signal to the switch element during a preset delay time, and allowing a compensation unit configured to receive the ON signal to adjust output of the power module during the preset delay time; and
when the delay time has elapsed after the latch receives the ON signal, terminating adjustment of the output of the power module using the compensation unit, and adjusting the output of the power module using the switch element.

10. The method of claim 9, wherein the adjustment of the output of the power module is performed by adjusting a voltage value applied to a gate of a MOSFET constituting the power module.

11. The method of claim 10, wherein a voltage value applied to the gate of the MOSFET by the switch element is greater than a voltage value applied to the gate of the MOSFET by the compensation unit.
